(19) United States
(12) Patent Application Publication
(10) Pub. No.: US 2024/0001173 A1
(43) Pub. Date: Jan. 4, 2024

(54) A FACE SHIELD

(71) Applicant: VISIONAIR LAB SRL, MASSA (MS) (IT)

(72) Inventor: Michele BONI, MASSA (MS) (IT)

(21) Appl. No.: 18/255,802

(22) PCT Filed: Dec. 1, 2021
(86) PCT No.: PCT/IT2021/050391

§ 371 Date: Jun. 2, 2023

(30) Foreign Application Priority Data
Dec. 4, 2020 (IT) 102020000029870

(51) Int. Cl. A62B 18/00

(52) U.S. Cl. CPC A62B 18/003

(57) ABSTRACT

Disclosed is a face shield including a structure for application and fastening to the head of a user, and including: at least one fan, associated with the structure for application and fastening; a first manifold, in fluid connection with the at least one fan, with an indicatively arched shape, including a slot positioned at its base which runs along it substantially for the whole of its length; operating controls and battery operated electrical power supply. The manifold coacts with the at least one fan to create an air blade exiting from the slot around the face of the user. This device further includes a filter to purify the air, associated with the at least one fan, and the manifold includes a plurality of holes adapted to feed air purified by the filter into the space included between the air blade and the face of the user, through the holes.

### TECHNICAL FIELD

The invention addresses the technical field of personal protective equipment commonly used in the industrial or medical field and of personal safety in general.

More in detail, the invention relates to a face shield in which the conventional physical protective shield made of solid material, such as plastic, is replaced by a protective barrier of a different kind.

### BACKGROUND ART

The term “Personal Protective Equipment” (PPE) identifies various types of equipment that can be worn, having the function of protecting the health and safety of the wearer from risks deriving from contact with harmful substances or with pathogens.

In particular, these devices comprise:
respiratory masks, more simply called face masks, adapted to protect the respiratory system from the possible inhalation of harmful substances or pathogens;
face shields, adapted to protect the eyes from possible contact with harmful substances or with pathogens.

Respiratory masks consist of a flexible filtering structure, shaped to adhere to the lower portion of the face (chin, mouth, nose), held in place by adjustable elastic loops or straps, which pass respectively around the ears or around the head of the wearer.

Respiratory masks protect the respiratory system of the wearer from the possible inhalation of various types of harmful substances or pathogens, according to the following classifications:
FFP1 masks, suitable to prevent the inhalation of airborne dusts or suspensions that are not particularly toxic but potentially responsible for lung diseases (coal, iron, zinc, aluminium, concrete, etc.);
FFP2 masks, suitable to prevent the inhalation of airborne dusts or suspensions of industrial origin (glassworks, foundry, construction, pharmaceutical, agriculture, etc.) and of pathogens (influenza viruses, coronaviruses, etc.);
FFP3 masks, suitable to prevent the inhalation of airborne dusts or suspensions containing very small particles (asbestos, silica, etc.);
medical or surgical masks, suitable to prevent the outward transmission of respiratory droplets contained in the exhaled breath of the wearer.

Face shields of known type are normally composed of a solid shielding structure, shaped to cover the entire face of the wearer, held in place by elastic straps or bands that surround the head of the wearer and of soft spacers that rest against the forehead of the user.

Face shields protect the eyes of the wearer from contact with respiratory droplets transmitted by people nearby, while they do not provide any protection against the inhalation of harmful substances present in the environment, and therefore the wearer must also wear a respiratory mask.

While efficient in their protective function, the aforesaid respiratory masks and the aforesaid face shields have numerous critical points related to the shape of their structure and to their specific mode of use.

In particular, respiratory masks have the following critical points:
they cover the nose and the mouth, making it difficult to breath;
as they cover the mouth, they make conversation difficult, as the conceal the movement of the lips preventing reading of the lips, they alter the function of the facial muscles and muffle the sound of the voice, etc.;
as they cover the nose, the mouth and the chin, they increase facial sweating in the covered area of the face;
as they cover the nose, the mouth and the chin they are uncomfortable to wear for long periods of time and cause facial pain in the covered area of the face;
they make the use of eyeglasses difficult, as the increase fogging and can cause them to fall off;
they must be removed in order to eat or drink, leaving the wearer temporarily unprotection.

Instead, face shields have the following critical points:
they are uncomfortable to wear as they cover the whole face and are rigid and bulky;
they increase facial sweating of the whole face;
they make the use eyeglasses difficult;
they must be removed in order to eat or drink, leaving the wearer temporarily unprotection.

Moreover, the above-mentioned critical points increase in the case of the combined use of respiratory masks and face shields.

### Presentation of the Invention

The object of the invention is to overcome the above-mentioned critical points of current respiratory masks and of current face shields.

The object of the invention is achieved with a face shield according to the main independent claim 1.

Further features of this face shield are set forth in the dependent claims.

A face shield according to the invention achieves the following important advantages:
through the use of a fluid dynamic protective barrier, an air blade, in substitution of the solid protective shield, it delimits the confined space between said barrier and the face of the user, invisibly separating it from the outside environment, producing, due to the accelerated air that although being a fluid acts almost as if it were a solid substance, a sort of air barrier to be worn, i.e., a personal air barrier, an invisible, interactive and selectively activatable protection, in this way protecting the eyes, the nose and the mouth of the user from possible contact with respiratory droplets transmitted by people nearby without the use of a barrier in solid material,
through said protective barrier, which delimits a portion of space that can be supplied with further purified air in addition to the air that forms the fluid dynamic shield, as well as the nose and the mouth of the user, it also protects the whole respiratory system against the inhalation of harmful substances (polluting, toxic etc.) and of pathogens (viruses, bacteria, etc.) dispersed in the surrounding environment;
through said fluid dynamic protective barrier, it delimits a portion of space with continuous air exchange that decreases facial sweating of the user;
through specific air insufflation devices in the portion of space confined by said fluid dynamic protective barrier, a positive pressure is created in said space, which facilitates breathing of the user, prevents the entry of untreated and potentially polluted air from the outside during inhalation, it makes it possible to filter only the air destined to be breathed by the user, increasing the duration of the filtering system;
through said fluid dynamic protective barrier, it allows the user to eat or drink without removing it from the face;
due to its ergonomic shape which can be reproduced in scale, it is suitable both for adults and children;
through biometric sensors, it allows physiological parameters of the user to be detected (heart rate, blood oxygen levels, etc.);
through proximity sensors, it allows the presence or absence of people nearby to be detected, so as to be able to activate, deactivate or modulate the fluid dynamic protective barrier, in order to save energy;
through sensors to detect the velocity of the air, it allows the presence or absence of atmospheric wind, or apparent wind due to the movement of the user, to be detected, so as to be able to activate, deactivate or modulate the fluid dynamic protective barrier, in order to save energy;
through sensors to detect the concentration of pathogens or pollutants, it allows the level of environmental risk to be detected, so as to be able to activate, deactivate or modulate the fluid dynamic protective barrier, in order to save energy;
through wireless communication interfaces, it allows connection to various types of portable electronic devices (mobile phones, tablets, videogame consoles, etc.).

### BRIEF DESCRIPTION OF THE DRAWINGS

The advantages of the invention will be more apparent below, from the description of different embodiments, provided by way of non-limiting example, and with the aid of the figures, wherein:

FIGS. 1-2-3 show, with partially sectioned side, front and top views, respectively, the inner and outer structural shape of a face shield according to a first variant of the invention;

FIGS. 4-5-6-7-8 show in a partially sectioned perspective view, in a top view, in a partially sectioned front view, in a section along the line VII-VII of FIG. 5 and in a section along the line VIII-VIII of FIG. 6, respectively, a component of the face shield according to said first variant of the invention;

FIGS. 9-10-11-12-13 show, in a partially sectioned perspective view, in a top view, in a partially sectioned front view, in a section along the line XII-XII of FIG. 10 and in a section along the line XIII-XIII of FIG. 11, respectively, a component of the face shield according to a different variant of the invention;

FIGS. 14-15-16-17-18 show, in a partially sectioned perspective view, in a top view, in a partially sectioned front view, in a section along the line XVII-XVII of FIG. 15 and in a section along the line XVIII-XVIII of FIG. 16, respectively, a component of the face shield according to further variant of the invention.

### DETAILED DESCRIPTION OF A PREFERRED EMBODIMENT OF THE INVENTION

With reference to the details of the figures, a face shield V according to the invention, in a simplified version, substantially comprises:
a structure 1 for application and fastening to the head of a user U;
at least one fan 2, for example of centrifugal type, arranged on one of the sides of said structure 1 for application and fastening, aligned (or in a variant arranged orthogonally) with respect to said structure 1;
at least one first manifold 3, associated with said at least one fan 2;
operating controls and battery operated electrical power supply means.

The manifold 3 is in fluid connection with the at least one fan 2, has an indicatively arched shape and comprises a slot 6 positioned at its base which runs along it uninterruptedly substantially for the whole of its length.

The slot 6 is adapted to generate, through acceleration of the air flow coming from the at least one fan 2, a continuous air blade L exiting from the manifold 3 and shaped to protect the front and sides of the face of the user U.

In this face shield V, the manifold 3 thus coacts with the at least one fan 2 to create an air blade L around the face of the user U, adapted to form an invisible fluid dynamic barrier, to protect the eyes, the nose and the mouth from possible contact with pollutants present in the environment or pathogens present in the respiratory droplets transmitted by people nearby. The same barrier also prevents the respiratory droplets transmitted by the user from reaching the outside environment.

The structure 1 indicatively is crown shaped and comprises:
a front portion 4, comprising deformable means adapted to adapt to the anatomical shape of the forehead of the user U to close the top part of the space S delimited by the air blade L;
a rear portion 5, comprising adjustment means, for example elastic bands, or straps of variable length, adapted to fasten it and maintain it in position on the head of the user U.

The operating controls (not illustrated) comprise:
electric switching means, arranged on the structure 1, to allow manual activation of the face shield V by the user U;
proximity sensor or similar means, also arranged on the structure 1, adapted to cause switching off or reactivation or automatic modulation of the face shield V depending on whether the presence of people nearby the user U is detected;
sensor means to detect the velocity of the air, adapted to detect the presence or absence of atmospheric wind, or apparent wind due to the movement of the user, so as to be able to activate, deactivate or modulate the fluid dynamic protective barrier, in order to save energy;
sensor means to detect the concentration of pathogens or pollutants, adapted to allow the quality of the ambient air to be detected and to be able to activate, deactivate or modulate the fluid dynamic protective barrier, in order to save energy.

The battery power supply means (not illustrated) comprise:
electric accumulator means, replaceable or rechargeable, adapted to be housed inside the structure 1 or outside and electrically connected thereto.

In a possible variant of embodiment, a face shield V according to the invention further comprises:
purifying filtering means 7, associated with the at least one fan 2;
a plurality of holes 9 positioned at the base of the manifold 3 so as to be closer to the face of the user U with respect to the slot 6.

Alternatively to said variant, the holes 9 are positioned at the base of a second manifold 8, also in fluid connection with the at least one fan 2, with an indicatively arched shape, arranged on the side of the manifold 3 facing toward the face of the user U.

In this variant, the holes 9 feed filtered and purified air A into the space S comprised between the air blade L and the face of the user U, thereby creating a positive pressure inside said S space delimited by the air blade, which facilitates breathing of the user and protects against the entry and possible inhalation of harmful substances or pathogens dispersed in the surrounding environment.

The purifying filtering means 7, of the type with replaceable cartridges, are adapted to eliminate harmful substances (dusts, particulate, etc.) and pathogens (viruses, etc.) from the air treated.

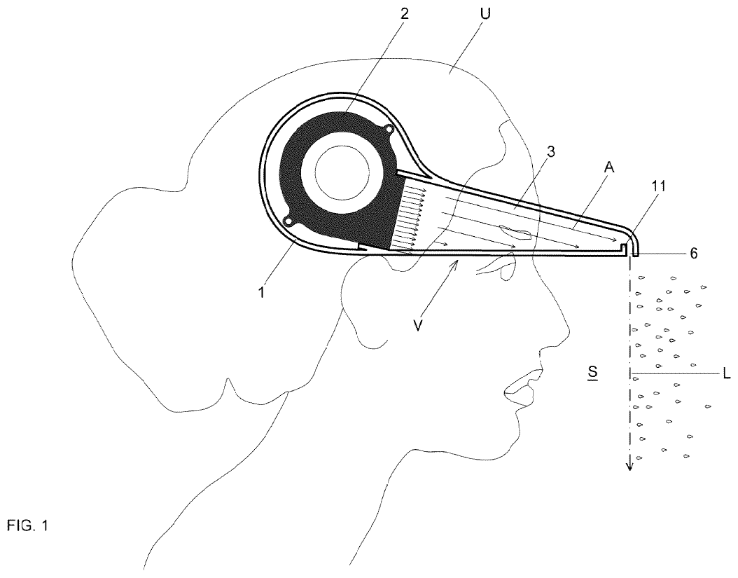

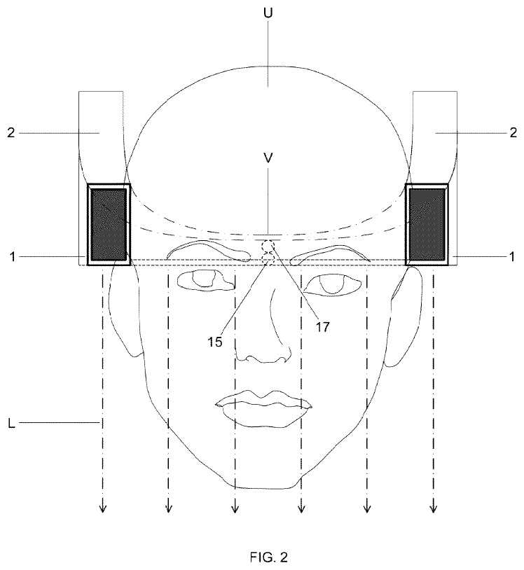

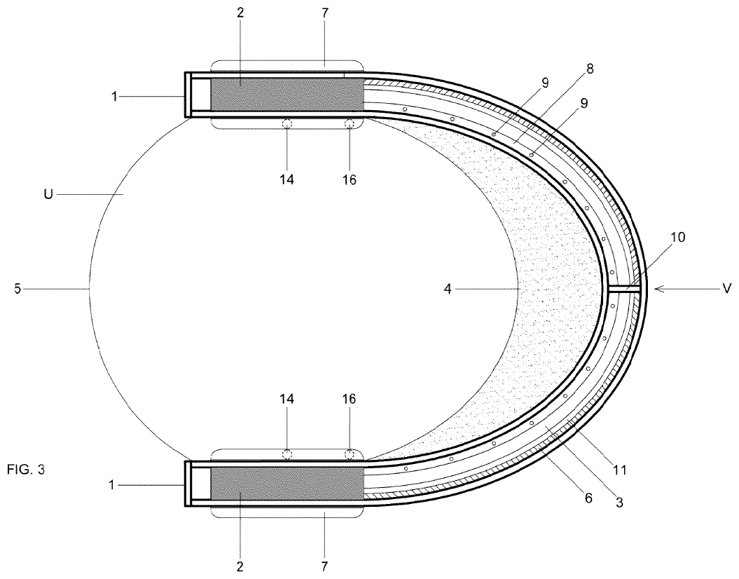

In a preferred embodiment of the invention, illustrated in FIGS. 1-18, the face shield V comprises a pair of fans 2, arranged on the opposite sides of the structure 1 and in fluid connection jointly or severally with the ends of the manifolds 3 and 8.

In this variant the manifold 3 comprises a partition 10 that divides it into two independent half-manifolds, each in fluid connection with a fan 2.

Each half-manifold has a flow section for the air gradually decreasing from the fan 2 toward the partition 10.

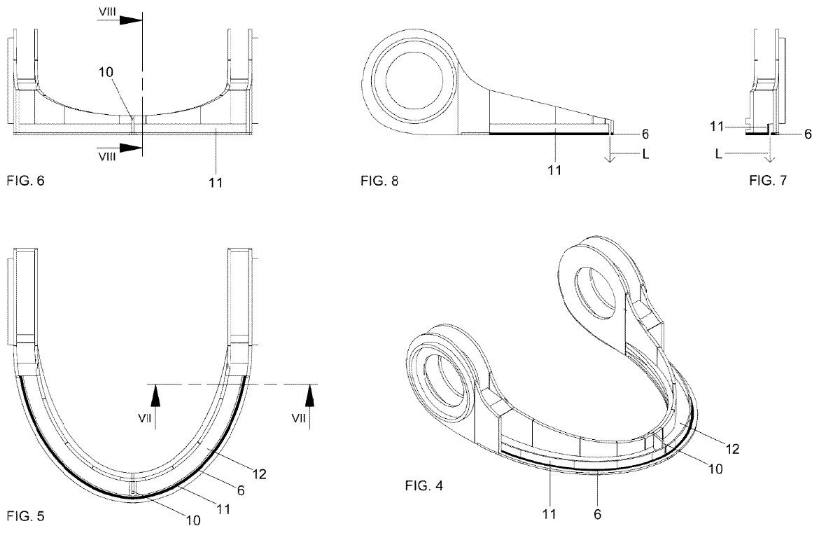

With reference to the variant of the invention illustrated in FIGS. 4-8, where to facilitate representation the structure 1 is shown without front and top closure, each half-manifold comprises a wall 11 that rises from the bottom of the manifold in front of the slot 6 for a constant height, smaller than that of the manifold, so as to form a pre-chamber 12 for diffusion of the air insufflated by the fan 2.

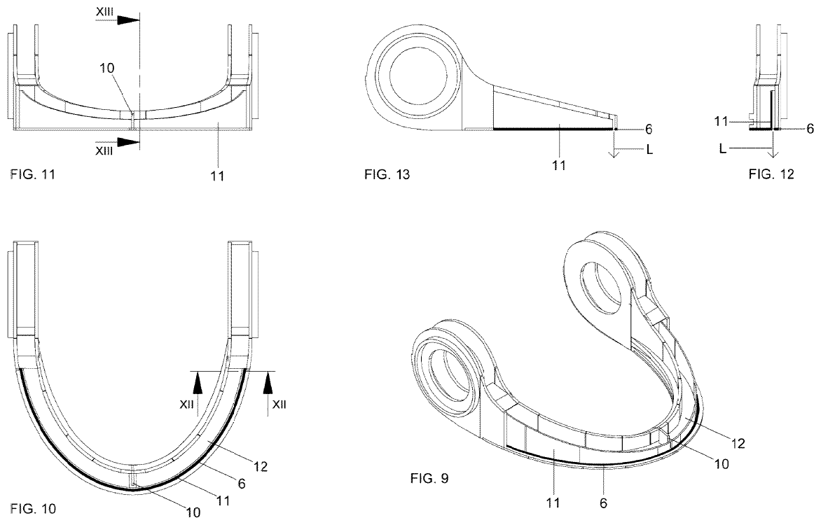

In an alternative variant of the invention illustrated in FIGS. 9-13, said wall 11 has a uniformly variable height, from the fan 2 to the partition 10, to follow the trend of the section of the respective half-manifold.

Naturally, based on experience the person skilled in the art can choose the height of the wall 11, its trend and the inclination, factors that determine the shape and size of the pre-chamber 12.

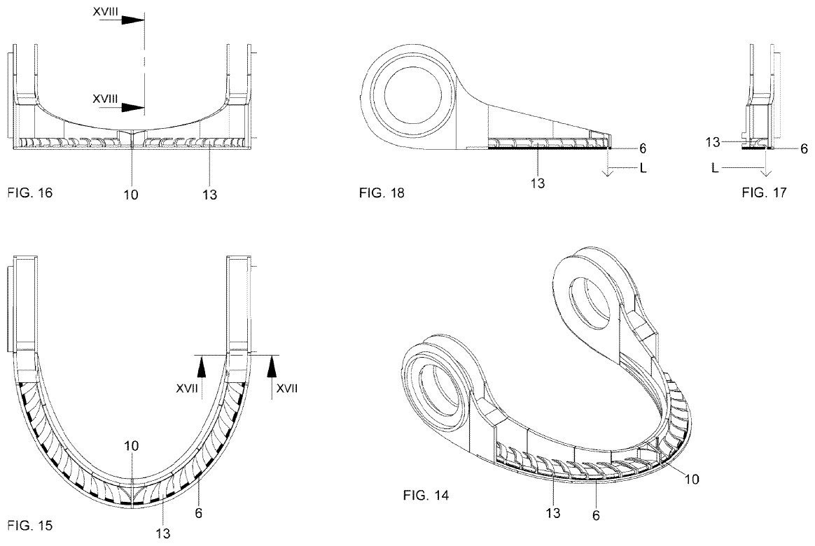

In a further variant of the invention illustrated in FIGS. 14-18, each half-manifold comprises a plurality of distribution fins 13, which rise from the bottom of the manifold for a constant height, smaller than that of said manifold, and are adapted to divert the flow of air coming from the fan 2 toward the slot 6.

Advantageously, said fins extend for the whole of the cross section of the manifold 3, hence beyond the slot 6.

In an alternative embodiment of the invention, not illustrated, said fins can have a uniformly variable height, from the fan 2 to the partition 10, to follow the trend of the section of the respective half-manifold.

Naturally, based on experience the person skilled in the art can choose the number, the shape and the height of the distribution fins 13.

To facilitate the creation of a laminar flow of air exiting from the slot 6, in a variant, not illustrated, this comprises a conveyor, comprising two walls that elongate the slot 6 and guide the air exiting from said slot.

In the case of strong wind or high movement speeds of the user, in a further variant, not illustrated, the face shield further comprises a shield in the form of a sheet of transparent plastic material, a few centimetres in height, which can be reversibly applied to the structure 1 in front of the slot 6.

Regardless of the variant of embodiment, a face shield V according to the invention can comprise:
biometric sensor means 14, arranged inside the structure 1, in contact with the temples of the user U, adapted to allow the detection of physiological parameters (heart rate, blood oxygen levels, etc.);
a microphone 15 and earpiece 16, of wireless type, provided with related activation and adjustment buttons, also arranged inside the structure 1, close to the mouth and to the ears (or in contact with the bone) of the user U, adapted to be connected to portable electronic devices (smartphones, tablets, video game consoles, etc.) to allow telephone calls to be made or the use of multimedia content (music, videos, video games, etc.);
a video camera 17, arranged on the outside of the structure 1, adapted to allow video or image capture;
a night light (not illustrated), also arranged on the outside of the structure 1, adapted to allow identification of the user U in conditions of poor lighting or to light the way.

The operating principle of a face shield V according to the invention can be summarized as described below.

The crown shaped structure 1 is worn by the user U placing it on the head and blocking it in position by means of the rear portion 5.

Electric switches arranged on the structure 1 allow manual activation of the face shield V by the user U, while any proximity sensors, sensors for detecting weather conditions or the speed of the user, sensors for detecting the concentration of pathogens or pollutants also arranged on the structure 1, can determine its activation, deactivation or automatic adjustment depending on the presence of people nearby, on the presence of wind, on the presence of apparent wind due to the speed of movement of the user, on the presence of a certain concentration of pathogens or pollutants.

When the face shield V is activated, the at least one fan 2 feeds a continuous flow of air into the manifold 3 connected thereto.

The manifold 3 ejects the flow of air coming from the fan 2 at high speed, through the slot 6 arranged at its base.

The slot 6 transforms the flow of air coming from the fan 2 into an air blade L, adapted to define a continuous invisible fluid dynamic protective barrier, shaped to cover the front and the sides of the face of the user U.

Due to its constant downward movement, oriented by the manifold 3, the air blade L is able to block any pollutants present in the air or pathogens present in the respiratory droplets transmitted by people nearby the user U, thereby protecting the eyes, the nose and the mouth from possible contact therewith.

Unlike any other shield composed of more or less transparent solid material, due to its intangible nature and easy activation and deactivation, the air blade L allows the user U to eat and drink without removing the face shield V from the head, while due to its perfect invisibility it does not obstruct conversation with other people, who can continue to read the lips of the user U wearing the face shield V.

In the variant in which holes 9 are provided for the feed of purified air into the space S, besides protecting the user U from the possible inhalation of harmful substances or pathogens dispersed in the environment, the purified air A creates a positive pressure in the space S that offsets the negative pressure created by the breath of the user U and consequently prevents any harmful substances or pathogens from penetrating the space S at the margins of the air blade A. The purified air A facilitates breathing by the user U and moreover decreases the temperature in the space S, thereby limiting facial sweating by the user U.

1. A face shield comprising a structure for application and fastening to the head of a user, the face shield comprising:
at least one fan, associated with the structure for application and fastening;
a first manifold, in fluid connection with the at least one fan, with an indicatively arched shape, comprising a slot positioned at the first manifold's base which runs along the first manifold substantially for the whole of the first manifold's length;
operating controls and battery operated electrical power supply means,
where said manifold coacts with said at least one fan to create an air blade exiting from said slot around the face of the user.

2. The face shield ( ) according to claim 1, further comprising a pair of fans, arranged on the opposite sides of the structure 1 and of said first manifold.

3. The face shield (V) according to claim 2, wherein said first manifold comprises a partition that divides the first manifold into two independent half-manifolds, each in fluid connection with a fan.

4. The face shield (V) according to claim 2, wherein said manifold comprises a wall that rises from the bottom of the manifold in front of the slot so as to form a pre-chamber for distribution of the air insufflated by the pair of fans.

5. The face shield according to claim 4, wherein said wall alternatively has a constant height, smaller than that of the manifold, or uniformly variable height, from the pair of fans toward a central portion of the manifold.

6. The face shield according to claim 2, wherein the manifold comprises a plurality of distribution fins adapted to diver the flow of air coming from the pair of fans toward the slot.

7. The face shield according to claim 6, wherein said distribution fins extend for the whole of the cross section of the manifold, to beyond the slot.

8. The face shield according to claim 6, wherein said distribution fins rise from the bottom of the manifold, alternatively, for a constant height, smaller than that of the manifold, or for a uniformly variable height, from the pair of fans toward a central portion of the manifold.

9. The face shield according to claim 1, further comprising filtering means to purify the air, associated with the at least one fan, and wherein said manifold comprises a plurality of holes adapted to feed air purified by the filtering means into the space comprised between the air blade and the face of the user, through said holes.

10. The face shield according to claim 9, further comprising a second manifold in fluid connection with said at least one fan, comprising said plurality of holes.
